(19) United States
(12) Patent Application Publication
(10) Pub. No.: US 2010/0323118 A1
(43) Pub. Date: Dec. 23, 2010

(54) DIRECT THERMAL SPRAY SYNTHESIS OF LI ION BATTERY COMPONENTS

(76) Inventors: Pravansu S. Mohanty, Canton, MI (US); Nicholas Anton Moroz, Northville, MI (US); Satish B. Chikkannanavar, Inkster, MI (US); Ramesh Kumar Guduru, Canton, MI (US)

Correspondence Address: HARNESS, DICKEY & PIERCE, P.L.C., P.O. BOX 828, BLOOMFIELD HILLS, MI, 48303, US

(21) Appl. No.: 12/855,789

(22) Filed: Aug. 13, 2010

Related U.S. Application Data
(63) Continuation-in-part of application No. 12/772,342, filed on May 3, 2010.
(60) Provisional application No. 61/174,576, filed on May 1, 2009.
(60) Provisional application No. 61/233,863, filed on Aug. 14, 2009.

(51) Int. Cl. C23C 4/04; B05D 1/08

(52) U.S. Cl. 427/447; 427/446

(57) ABSTRACT

A method of fabricating a battery member from a precursor comprising providing a precursor having at least one component dissolved in the precursor; and thermal spray depositing the precursor on a substrate to form a coating layer such that the at least one component is synthesized within the thermal spray prior to being deposited on the substrate.

### CROSS-REFERENCE TO RELATED APPLICATIONS

This application claims the benefit of U.S. Provisional Application No. 61/233,863, filed on Aug. 14, 2009. This application is also a continuation-in-part of U.S. patent application Ser. No. 12/772,342 filed on May 3, 2010, which claims the benefit of U.S. Provisional Application No. 61/174,576 filed on May 1, 2009. The entire disclosures of each of the above applications are incorporated herein by reference.

### GOVERNMENT INTEREST

This invention was made with government support under Grant No. N00244-07-P-0553 awarded by the U.S. Navy. The government has certain rights in the invention.

### FIELD

The present disclosure relates to manufacturing of Li-ion batteries and, more particularly, relates to deposition apparatus, schemes and recipes for direct synthesis of electrode materials and components using thermal spray processes in combination with in situ microstructure modification with a heat source.

### BACKGROUND

This section provides background information related to the present disclosure which is not necessarily prior art.

Rechargeable Li ion batteries have many applications in automobiles, electronics, biomedical systems, aerospace systems and other personal applications. The need for improving the electrode characteristics for Li ion batteries to achieve better specific capacity and cycling characteristics has been realized for sometime. Over the years researchers have focused on controlling the material chemistry, microstructure and particulate size to achieve better performance.

With particular reference to FIG. 1, Li ion battery cells typically comprise an anode, a separator, a cathode and an electrolyte enabling ionic communication between the anode and the cathode for battery operation. Different materials are being tested for these components in the industry. For example, material chemistries such as LiFePO4, LiCoO2, LiMn₂O₃ and Li[NixCo1-2xMnx]O2 are being explored for the cathode. Material chemistries such as graphite, carbon coated silicon, Li₄Ti₅O₁₂, CO₃O₄, and Mn₃O₄ are being explored for the anode. The electrolytes can be either liquid or solid or a combination thereof. The separators are typically porous membranes.

Among various materials used for the cathode, Fe-based phosphates are attractive materials for their low cost and non-toxicity. The olivine structured LiFePO₄ was first developed at the University of Texas by John Goodenough et al. in 1996. Since then, various improvements have been made to the production of LiFePO₄ in order to increase the surface area of the particles as well as providing conductive channels for enhanced electron and ion transport.

LiFePO₄ can be synthesized using one of the various approaches such as high temperature solid state chemical reaction, the sol-gel process, hydrothermal synthesis, or by spray pyrolysis. Whereas it is relatively straightforward to synthesize the olivine phase, each of these methods also requires a final sintering of the material around 700° C. in an inert atmosphere to remove a ferric layer (due to oxidation of Fe²⁺) and correctly order the iron atoms so that it does not block diffusion of the lithium ions during charge/discharge process. This final step can typically take several hours to complete for even a small amount of the material.

LiFePO₄ does have a very high theoretical specific capacity, however the material shows very low conductivity at room temperature. An option proposed by Ravet et al., is to coat the particles of LiFePO₄ with a conductive material such as carbon. Song et al. were able to add carbon to the particles of LiFePO₄ by simply ball milling the particles with acetylene black. This process increased the conductivity of the sample by eight-fold. Bewlay et al. coated LiFePO₄ particles with carbon by adding sucrose to a direct decomposition reaction of LiCO₃, FeC₂O₄.2H₂O, and NH₄H₂PO₄. Carbon has also been inserted by pyrolizing the LiFePO₄ solution through a hydrocarbon, such as propane. Other additives, such as small amounts of niobium, titanium and magnesium have also successfully boosted the conductivity of LiFePO₄.

Irrespective of cathode or anode material, the particulate size, structure, phase and additives are important characteristics that need to be carefully controlled for optimum battery performance. With their high surface area, nanoparticulate materials with appropriate lattice structure, facilitate the easy insertion and extraction of Li ions and effectively accommodate the severe strain induced during battery operation. Further, carbon based additives have shown enhanced charge/discharge performance. The end product of all the synthesis processes is usually powders, which are subsequently mixed with conductive additives and binders. The slurry mixture is then deposited onto the charge collector as a film to form the electrode. Therefore, the powder production is typically done in batches off the cell assembly line.

Alternatively, techniques such as pulsed laser deposition and radiofrequency magnetron sputtering have also been employed to achieve the desired films directly onto the electrodes, however the process usually starts from a preprocessed target of the desired electrode material and typically offers very slow film growth rates in the order of nm/min.

Researchers also have explored approaches to deposit pre-synthesized powders especially for the anode using high volume deposition processes such as plasma spray process. Although high volume deposition can be achieved, the powder material still needs to be synthesized by conventional approaches mentioned above.

In regards to electrolytes, liquid electrolytes typically comprise of LiPF6 dissolved in ethylene carbonate (EC) and dimethyl carbonate (DMC). Alternately, Bis(trifluoromethane)sulfonimide lithium salt in EC/DMC mixture is also used as liquid electrolyte. Liquid electrolytes are commonly added into the cell during cell assembly which is a low temperature process as the liquid electrolytes cannot tolerate high temperature operation.

Solid electrolytes based on Li₁₊ₓAlₓTi₂₋ₓ(PO₄)₃ [LATP] (x: 0.2-0.5) have been studied for their use in Li ion rechargeable batteries. These materials possess NASICON type structure and high ionic conductivities for Li ions and well suited for operation at elevated temperatures. Most of the solid electrolytes are synthesized through solid state or sol-gel methods like the cathode materials and the glassy phase powder is achieved through rapid quenching from the high temperature annealed state.

Apart from cathodes, anodes and electrolytes, the separator plays a vital role in the performance of Li ion batteries. A separator which possesses high surface area, porosity and good mechanical strength is desirable for best performance. For past several years researchers have focused on polyvinylidene fluoride (PVDF) based membranes for separators which exhibit better performance relative to existing materials based on polypropylene.

Accordingly, the industrial battery manufacturing techniques of the present teachings comprise a multi-step material synthesis, component fabrication and assembly process. For example, typical steps involved in cathode manufacturing are schematically shown in FIG. 2A. As a result, the current cost of Li batteries ($/kwh) is very high. Further, the synthesis and assembly process also limit the geometric freedom of the battery cell.

### SUMMARY

This section provides a general summary of the disclosure, and is not a comprehensive disclosure of its full scope or all of its features.

This present disclosure provide for apparatus, schemes and recipes comprising the use of appropriate precursors for battery materials which are injected to a hot gaseous stream for chemical/thermal treatment and consolidation into the desired component layers of a battery cell. The spray/deposition process utilizes powder/liquid/gaseous precursors or a combination thereof to achieve different material combinations needed for Li ion battery components directly. When desired, a heat source, such as a laser beam or a heat source, provides further in situ heat treatment of the deposited material layers for microstructure and phase control required for optimum performance of the battery. The approach offers unique advantages in terms of process step elimination, geometric freedom and the method is scalable for large area electrode manufacturing and hence viable for industrial scale production.

In some embodiments of this disclosure, the current collectors, the electrodes, the electrolyte as well as the separator membrane and/or the combination thereof is manufactured according to the principles of the current teachings, enabling layer by layer fabrication of all the components of the entire battery cell. Thus, complex battery configurations can be achieved where the synthesis of the material and the assembly of the cell are performed in-line.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. For purposes of clarity, not every component is labeled in every figure, nor is every component of each embodiment of the disclosure shown.

FIG. 1 is a schematic view illustrating a Li-ion battery cell components according to various exemplary embodiments of the present disclosure;

FIG. 2A is a schematic flowchart illustrating a multi-step conventional processing approach for making a Li-ion battery cathode;

FIG. 2B is a schematic flowchart illustrating the direct synthesis and consolidation approach for making a Li-ion battery cathode according to the principles of the present teachings;

FIG. 3A is a schematic view of an exemplary embodiment of the present disclosure comprising the processing apparatus assembly of FIG. 2B;

FIG. 3B is a schematic view of an exemplary embodiment of the spray device of FIG. 3A comprising a DC plasma system along with a directional heat source;

FIG. 3C is a schematic view of an exemplary embodiment of the spray device of FIG. 3A comprising a combustion flame system;

FIG. 3D is a schematic view of an exemplary embodiment of the precursor feed device of FIG. 3A comprising three liquid precursor reservoirs with a mixing and pumping system;

FIG. 3E is a schematic view of an exemplary embodiment of the precursor feed device of FIG. 3A comprising liquid and solid precursor reservoirs;

FIG. 4A is a schematic view of a collection apparatus for powders synthesized from liquid precursors according to the principles of the present teachings;

FIG. 4B is a schematic view of an electrode material film being deposited employing particles synthesized from liquid and/or gaseous precursors according to the principles of the present teachings;

FIG. 4C is a schematic view of an electrode material film being deposited utilizing particles synthesized from solid/liquid and/or gaseous precursors according to the principles of the present teachings;

FIG. 4D is a schematic view of an electrode material film being deposited and in situ heat treated according to the principles of the present teachings;

FIG. 5A is a perspective view of an exemplary cathode illustrating a variety of morphological patterns and materials synthesized according to the principles of the current teachings;

FIG. 5B is a TEM image of LiFePO₄ cathode film synthesized directly from liquid precursors according to the principles of the current teachings;

FIG. 5C is a XRD pattern of LiFePO₄ cathode film synthesized directly from liquid precursors according to the principles of the current teachings;

FIG. 5D is a cyclic capacity plot of LiFePO₄ cathode fabricated directly from liquid precursors according to the principles of the current teachings;

FIG. 5E is a cyclic charge/discharge plot of LiCoO₂ cathode fabricated by Co film deposition and in situ lithiation according to the principles of the current teachings;

FIG. 6A is a perspective view of an exemplary anode illustrating a variety of morphological patterns and materials synthesized according to the principles of the current teachings;

FIG. 6B is a XRD pattern of CO₃O₄ anode film synthesized directly from Co powder precursor and in situ oxidation according to the principles of the current teachings;

FIG. 6C is a cyclic charge/discharge plot of CO₃O₄ anode of FIG. 6B fabricated according to the principles of the current teachings;

FIG. 7 is a perspective view of a system according to the principles of the present teachings illustrating roll-to-roll fabrication of component layers comprising multiple deposition systems;

FIG. 8A is a XRD pattern of an exemplary solid electrolyte layer fabricated according to the principles of the current teachings;

FIG. 8B is a perspective view of an exemplary battery cell manufactured layer by layer according to the principles of the current teachings;

FIG. 8C is an exploded view of an exemplary battery cell of FIG. 8A illustrating different layers;

FIG. 9A is a perspective view of an exemplary battery cell being deposited layer by layer on an airplane wing according to the principles of the current teachings;

FIG. 9B is a perspective view of an exemplary battery cell being deposited layer by layer under solar cells according to the principles of the current teachings; and

FIG. 9C is a perspective view of an exemplary battery cell being deposited layer by layer on an automotive structure according to the principles of the current teachings.

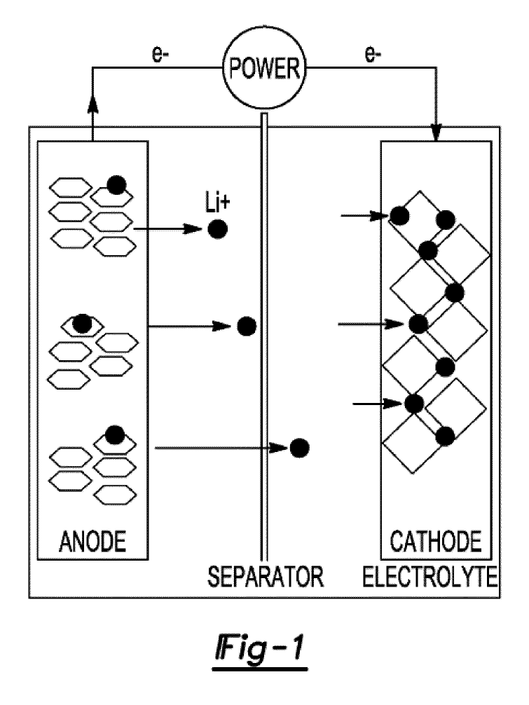

Corresponding reference numerals indicate corresponding parts throughout the several views of the drawings.

### DETAILED DESCRIPTION

Non-limiting embodiments of the present disclosure will be described by way of example with reference to the accompanying figures, which are schematic and are not intended to be drawn to scale.

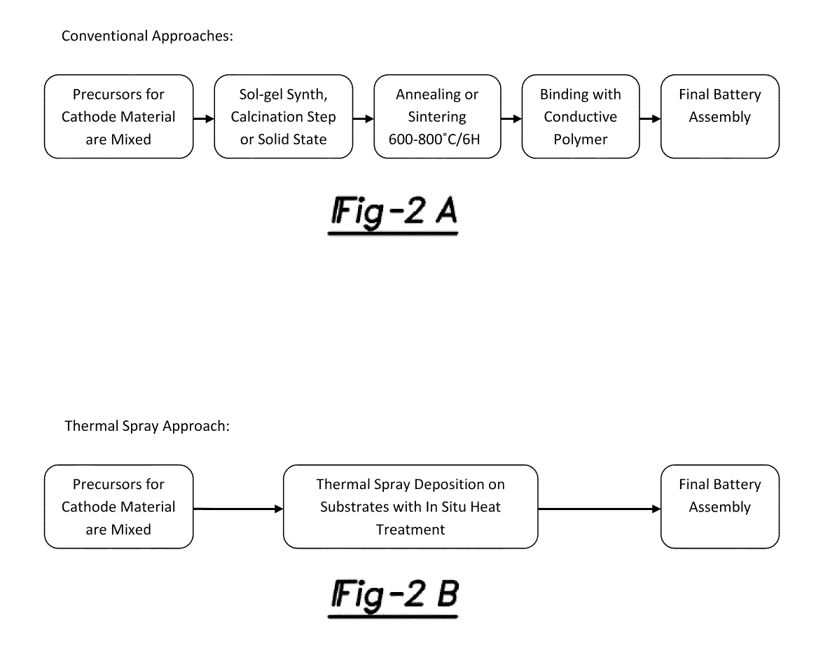

Referring initially to FIG. 2A, current synthesis approaches practiced for the preparation of battery electrodes involve many process steps and require several hours of processing time. New synthesis strategies which could reduce the processing time and simultaneously offer adequate control over material chemistry and morphology are of critical importance.

With particular reference to FIG. 2B, the current teachings provide manufacturing schemes to fabricate the electrodes and/or other components using an appropriate fluid precursor which is injected to a hot gaseous stream for chemical/thermal treatment and consolidation into the desired active layer of the electrode assembly. The fluid precursors upon injection into the hot gas pyrolyze in the stream resulting in fine molten/semi-molten/solid droplets of the desired materials that are consolidated into a film form. Further, when necessary, a heat source provides for in situ heat treatment of the film to optimize the chemistry, phase and morphology for enhanced battery performance.

Moreover, the novel manufacturing schemes of the present disclosure provide films possessing the desired morphological features, phase and compositions directly from chemical precursors, and thus, eliminate processing steps currently practiced in the industry. Further, the spray deposition techniques of the current teachings enable the creation of geometrically complex electrodes. Spray synthesis and consolidation according to the current scheme, can be performed under controlled atmosphere (e.g. N₂ or N₂/H₂) to prevent undesirable chemical conversion of certain elements in the formulation. In some embodiments, the use of fluid precursors where the component ingredients are in a completely dissolved state ensure homogeneity of component elements and enhance reaction rates compared to the solid state reactions commonly practiced in conventional processes, and thus can reduce the processing time.

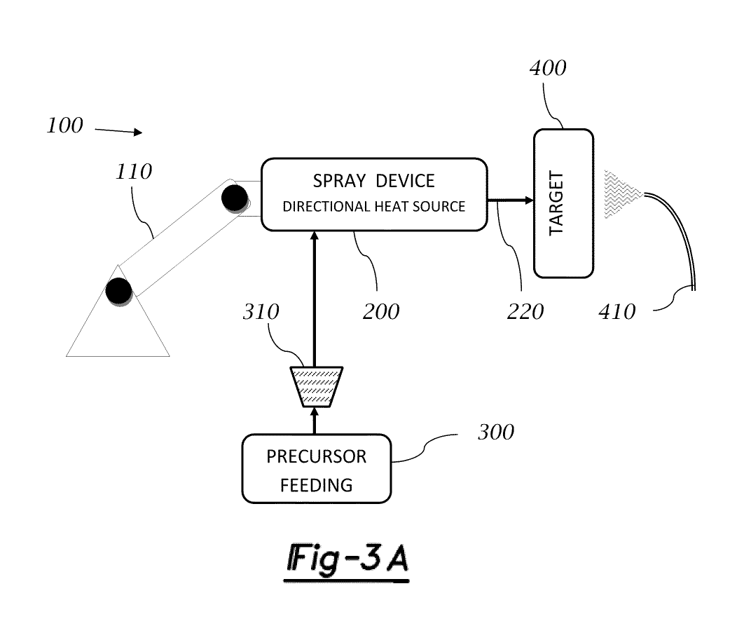

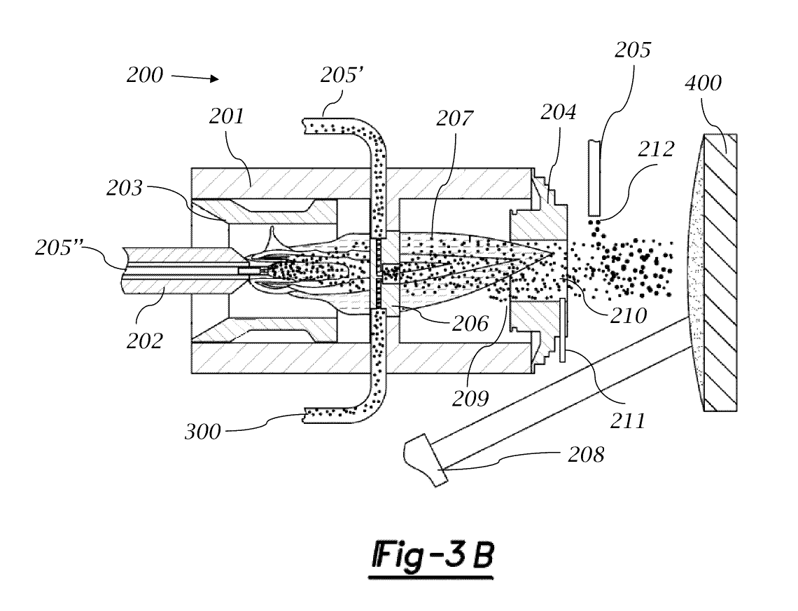

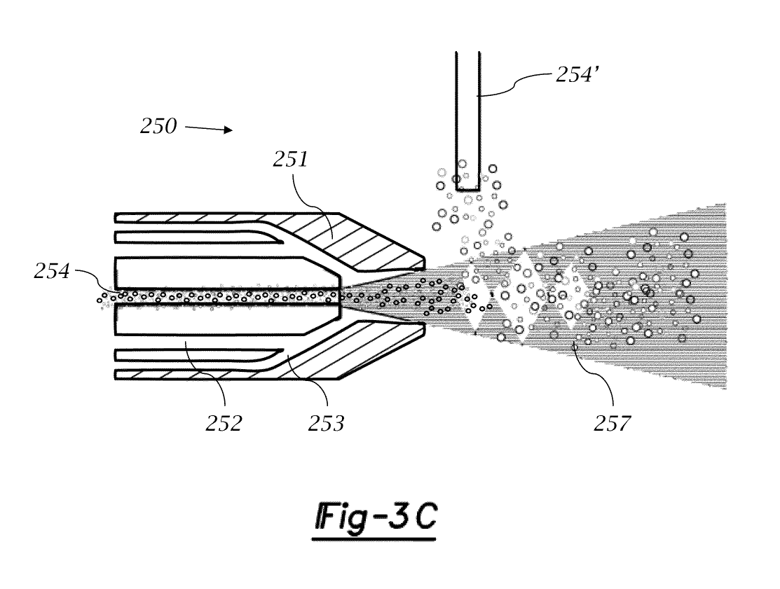

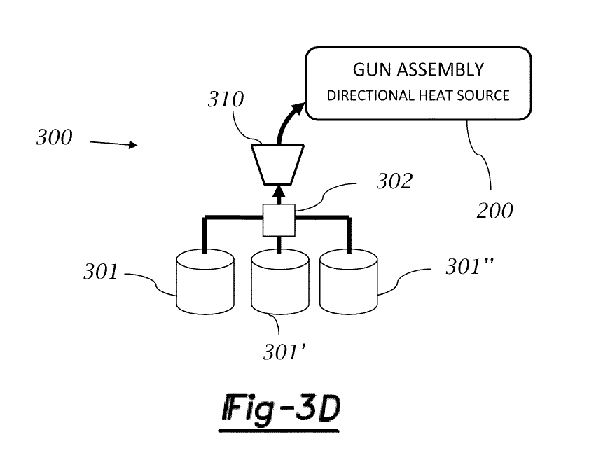

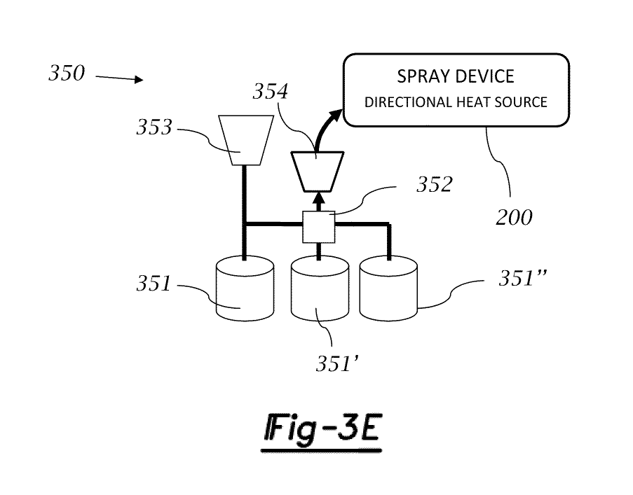

In some embodiments of the present teachings as shown in FIG. 3A, the fabrication apparatus assembly 100 comprises a motion system 110 that mechanically commutes the spray device 200 to build a uniform film on the target 400, utilizing the fluid precursors from reservoir 300 in measured quantities via a pumping system 310. In some embodiments, the target 400 is cooled from the back by a fluid stream 410. The apparatus assembly 100 can be installed in an inert environment.

Referring to FIG. 3B, in some embodiments, the spray device 200 can comprise a plasma gun 201 with fluid precursor injection elements 202 and/or 205 and/or 206. Using this approach, multiple precursors can be efficiently incorporated into the plasma stream 207; however, it is not necessary to employ all the fluid injection elements at a given time. The element 202 can be electrically charged as the cathode of the plasma device, while element 203 charged as the anode. In this configuration, the plasma is generated according to the principles of direct current plasma or DC plasma as commonly known in the literature. Conversely, in some embodiments, the element 202 remains electrically neutral and acts only as an injector/atomizer. In this configuration the plasma is generated by a surrounding RF induction coil (not shown for simplicity) according to the principles of inductively coupled plasma or ICP as commonly known in the literature.

Further, in some embodiments, the fluid precursor injection element 202 of FIG. 3B is used for utilizing gaseous and solid precursors. In the case of liquid precursors, a two fluid atomizer 205″ is utilized to atomize the liquid into sufficiently fine droplets which are entrained into the hot gas stream. In another embodiment, an atomizer assembly 206 having a liquid precursory input 300 and a gas input 205′ is collectively joined to introduce liquid droplets of precursor at a position downstream of the anode. Atomized precursor droplets undergo secondary atomization by the plasma jet 207 emerging through plasma paths resulting in fine droplets for material synthesis and deposition on a substrate or target 400. The atomizer assembly 206 is preferentially used for liquid or gaseous precursors or a combination thereof. Additionally, in some embodiments when atomizer assembly 206 is employed, precursor injection element 202 can be replaced with a solid element to act as the cathode of the DC plasma configuration.

In some embodiments of the present teachings, the exit nozzle 204 comprises of plasma inlet 209, plasma outlet 210 and gaseous precursor input 211. The gaseous precursor input 211 can introduce gases such as acetylene to coat or dope the molten particles with a desired material prior to deposition. This particular approach is beneficial for carbon doping that is required for enhancing the conductivity. The plasma outlet 210 can assume different cross sectional profiles such as cylindrical, elliptical and rectangular. Such renditions are beneficial to control the particle size distribution in the atomized droplets to enhance their synthesis characteristics.

Referring to FIG. 3B, the injection element 205 can introduce precursors radially to the plasma stream and is commonly known as a radial injector. This injector can be employed to inject solid/liquid/gaseous precursors 212 or their combinations. However, it is preferentially employed for precursors that need lower thermal input such as polymers or for delayed chemical activity in flight or at the target 400 as will be illustrated later in this disclosure. It is implicit that use of a specific injector or their combinations with specific precursors is non-limiting.

This design ensured the entrainment of all precursors in the plasma stream 207 leading to higher deposition efficiency and uniform particulate characteristics. Further, this design also enables embedment of nanoparticles into a bulk matrix resulting in composite films.

According to the principles of the present teachings, the spray device 200, as illustrated in FIG. 3B can be provided with a heat source 208 that is capable of treating the deposited material, layer by layer, nearly simultaneously as the layers are deposited by plasma stream 207 on the substrate. The energy source can be a laser, plasma, radiation or a convection heat source. That is, the energy output from a heat source 208 can be directed to coating deposited on a substrate using the methods set forth herein. In this regard, each thinly-deposited layer on a substrate can be immediately modified, tailored, or otherwise processed by the heat source 208 in a simple and simultaneous manner. Specifically, the heat source 208 is disposed adjacent or integrally formed with spray device 200 to impart energy upon the substrate being processed. In some embodiments of the present teachings the energy beam can assume either a Gaussian energy distribution or rectangular energy distribution.

In some embodiments of the spray device 250, a combustion flame is employed instead of plasma, as illustrated in FIG. 3C. The combustion apparatus can employ a fuel such as hydrocarbon or hydrogen 252 as well as oxygen or air 253 to generate a sufficiently hot flame 257. The precursor material can be injected to the flame axially via injector element 254 and/or radially via injector element 254′ to synthesize the desired material and consolidate them into a deposit on target 400 according to the principles of the current teachings set forth herein. The chemical environment of the flame can be adjusted either to oxygen rich or oxygen lean by adjusting the fuel to air ratio. Such adjustments can control the chemistry of the target material. The in situ heat treatment of thus deposited films can be carried out employing a heat source 208 according to the principles illustrated in this disclosure.

In some embodiments, the spray device 250 can employ a preheated gas stream to atomize the precursors into fine droplets that are consolidated on the target 400. While moisture loss from the precursor can occur in flight, the precursor conversion into the desired chemistry, phase and particulate morphology primarily occurs on the target by in situ heat treatment according to the principles of the current teachings set forth herein.

Referring to FIG. 3D, the precursor feed assembly 300 can comprise non-limiting precursor reservoirs 301, 301′ and 301″ feeding into a mixing chamber 302 which is pumped into the spray apparatus 200 via a mechanical pump 310. Further, as illustrated in FIG. 3E, the feed assembly 350 can comprise mechanical feeders 353 to incorporate solid powder precursors into the liquid precursor line forming a slurry that is pumped to the spray apparatus 200 via the mixing chamber 352 and the pump 354. Additionally, the solid precursors can also be fed independently via a carrier gas directly to the spray apparatus. Benefits of such renditions will further be explained later in this disclosure.

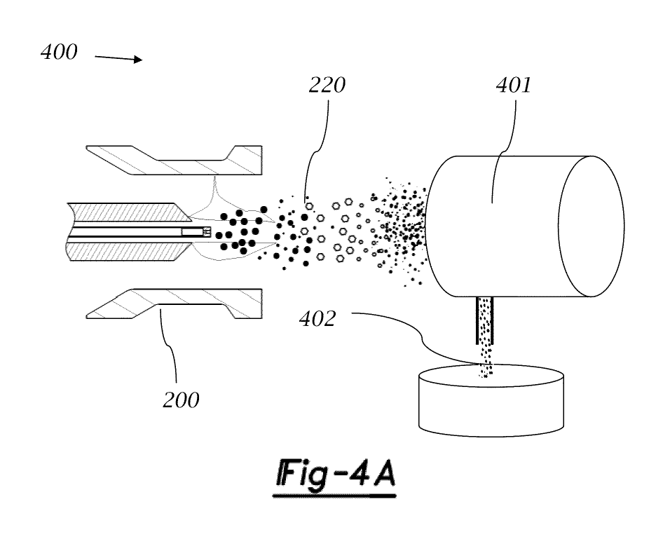

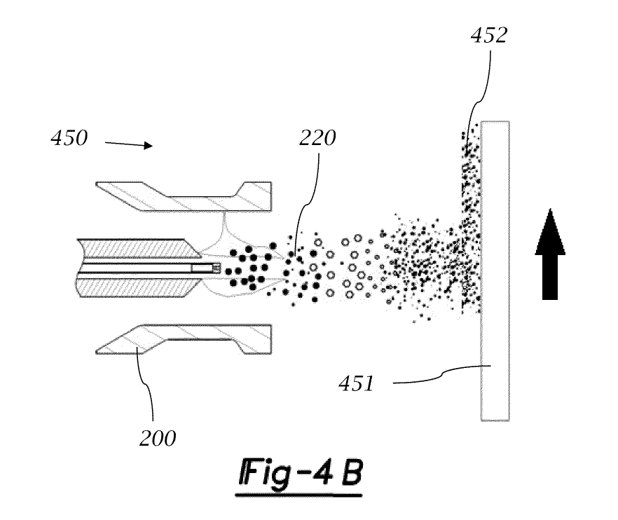

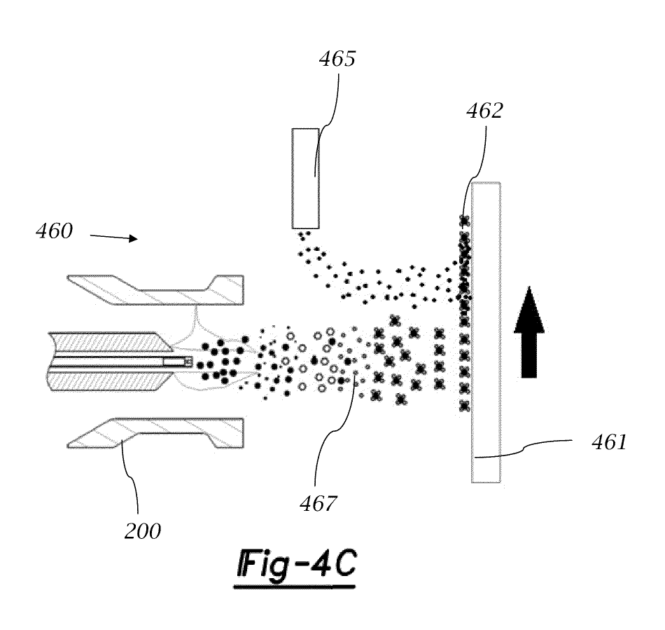

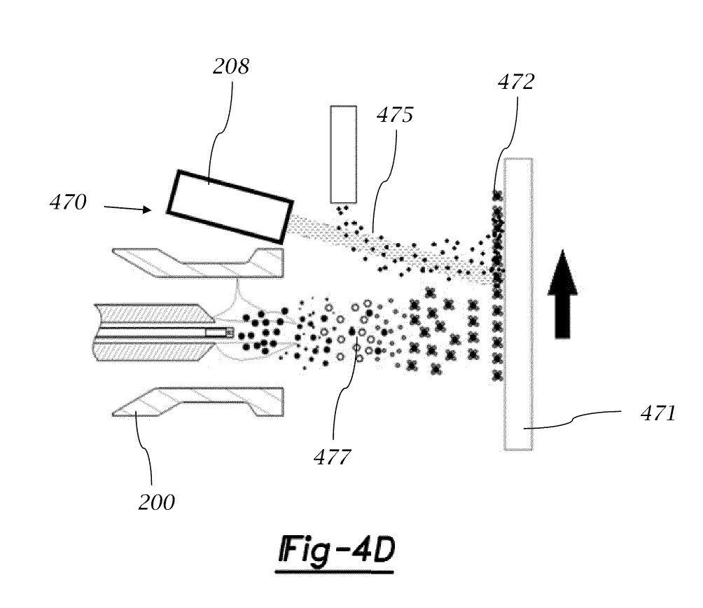

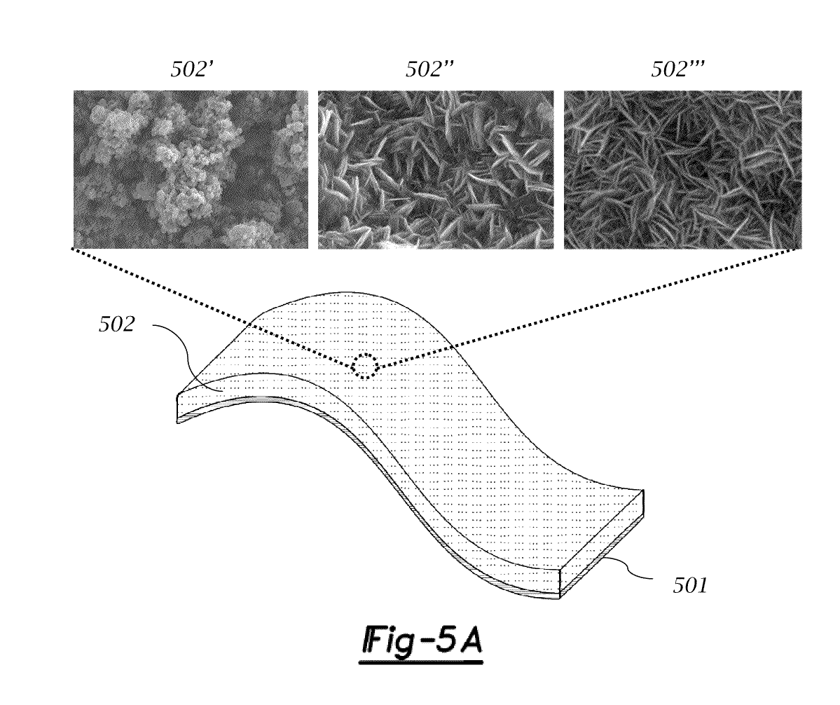

FIGS. 4A through 4D schematically illustrate various non-limiting embodiments of collection schemes for the spray synthesized material from the spray device 200 on the target 400 and providing in situ heat treatment therein. Referring to FIG. 4A, instead of consolidating the particles into a film form, the material is collected into a chamber 401 where it is annealed in flight to produce powders 402. In other words, the principles of the current teachings can be employed to manufacture powders of various battery material compounds for conventional fabrication schemes of the battery electrodes and electrolytes. FIG. 4B illustrates the direct consolidation of the electrode material 220 synthesized from precursor chemicals in film form 452 on the current collector 451. Further, FIG. 4C illustrates the schematics of a deposition technique from a mixture comprising suspended pre-synthesized particles in a liquid or gaseous precursor resulting in composite coatings. Additionally, other precursors can be utilized from external injector 465 to consolidate the film 462 on current collector 461. In situ heat treatment can be provided to the film 472 by employing a heat source 208 to the embodiments shown in FIGS. 4A through 4C as illustrated in FIG. 4D.

According to the principles of the present teachings, the spray apparatus 200, specifically having heat source 208, can be effectively used for the creation of battery components directly utilizing appropriate precursors. In this way, the current collectors, cathode, electrolyte, separator and the anode layers can be deposited by the spray apparatus 200 using either solid precursors, liquid precursors, gaseous precursors, or a combination thereof. In situ modification of the layers is achieved with the heat source 208. By carefully varying the heat source nature and power, one can grade the density (i.e. define a gradient) across the layers and its interfaces to enhance ion intercalation. In some embodiments, the spray apparatus 200 can further comprise the teachings set forth herein relating to cathode, electrolyte and anode variations.

Direct achievement of films with desired chemistry, phase and morphology from solution precursors using spray apparatus as described here has never been achieved in the prior art. Further, the deposition rates possible according to the principles of the current teachings are orders of magnitude higher than the conventional thin film deposition techniques. The direct synthesis approach gives the ability to adjust the chemistry of the electrode in flight and in situ. These teachings are not limited to the exemplary material systems discussed herein and can be employed to many other material systems.

### Innovative Cathode Manufacturing:

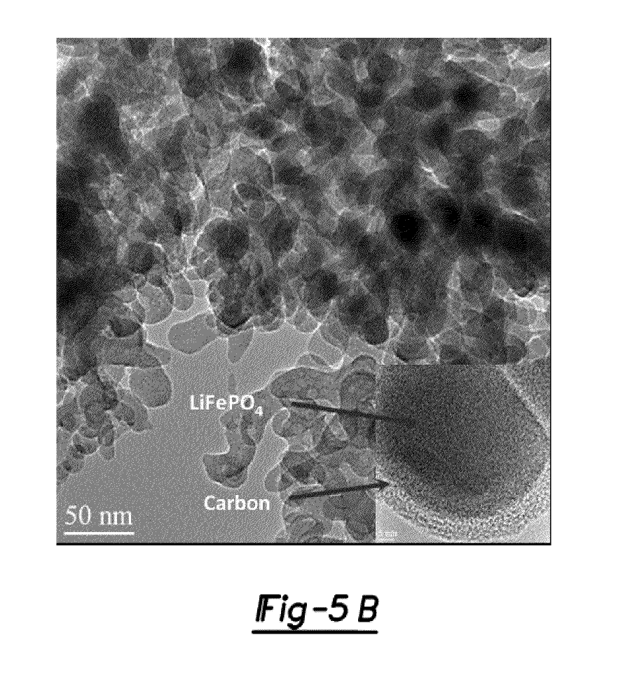

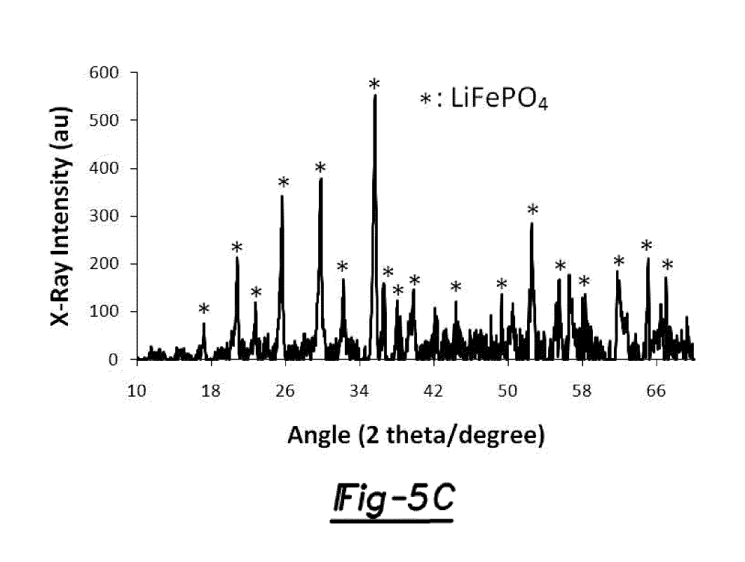

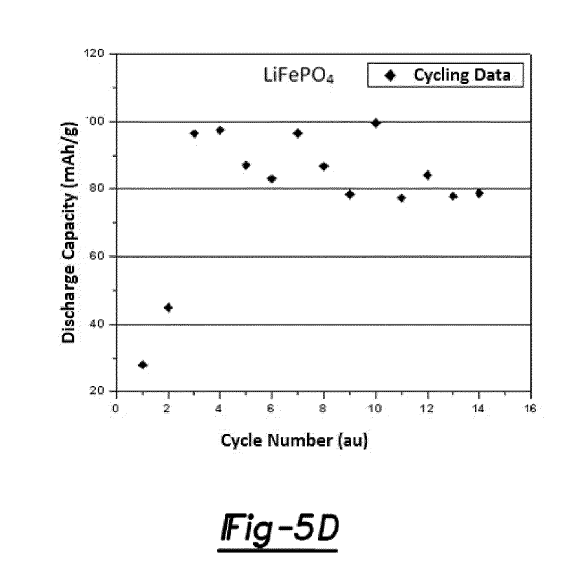

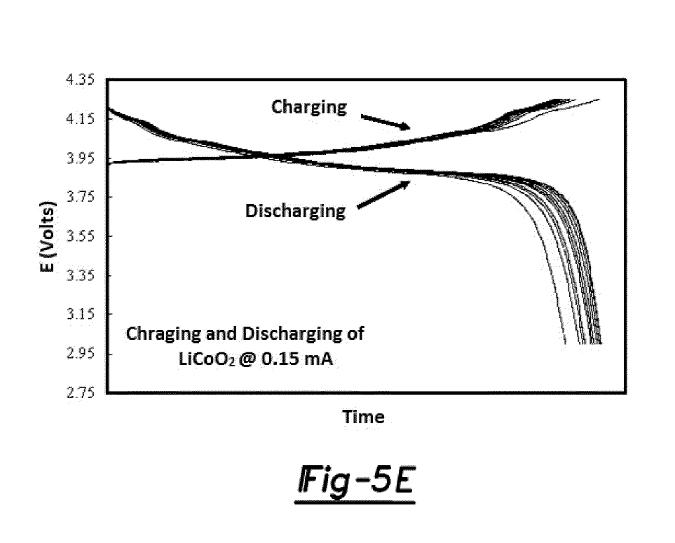

There are many cathode material chemistries currently being explored such as LiFePO4, LiCoO2 and Li[NixCo1-2xMnx]O2 etc. According to the principles of the present teachings, liquid precursors (chemical solutions and suspensions in carrier solutions) are introduced into spray system 20 of FIG. 3A to synthesize the desired material chemistry, phase and morphology, and directly form the cathodic film 502 in a unique manner on a current collector 501 as illustrated in FIG. 5A. The process is generally set forth in FIG. 2B, wherein processing steps in the prior art are eliminated. Furthermore, it should be appreciated that a heat source 208 can be employed to further treat the layers or film, if desired. FIG. 5A illustrates the morphology of LiFePO4 502′, LiCoO2 502″ and LiMn₂O₃ 502′″ cathodic films obtained according to the principles of the current teachings.

An exemplary precursor for LiFePO₄/C composite cathode comprises water, Iron Oxalate, LiOH, Ammonium Phosphate, and sugar in a pH adjusted solution. It should be noted that to achieve a pH adjusted solution, the addition of an acid or a base (dependent on the initial acidity or basicity) can be used. In some embodiments, the solution can be pH adjusted to achieve a homogeneous solution wherein the components contained there are completely dissolved in solution. Further, dopants such as Zr and Mn can be added using suitable nitrate precursors. In some embodiment, an axial proprietary atomizing injector 205″ or 206 is employed in the plasma device 201 of FIG. 3B. The atomizer uses the two fluid method, utilizing pressurized gas flow in order to break up the precursor solution into droplets roughly 1-50 micrometers in size. The atomization allows for the solution droplets to be completely pyrolyzed to LiFePO₄ particles at lower temperatures compared to a solution stream being directly injected into the plume. Further, one can also inject pre-synthesized LiFePO₄ solid powder into the plasma along with the solution precursor described herein to enhance the deposition rate. The resulting molten/semi-molten LiFePO₄ particles are deposited as a film 502′ onto a current collector 501 such as an aluminum foil as illustrated in FIG. 5A. Additional carbon can be added to the film via gaseous precursors as described in the current teachings.

The cathodic films obtained according to the principles of the current teachings may or may not contain any polymer binder like conventional cathodes used in the industry. The binderless cathodes can operate at higher temperature. However, the principles set forth herein do not limit the fabrication of cathodes with polymer binders. It has been possible to add polymers such as PVDF and PAA by co-spraying with the solution precursors.

The solution precursor was successfully pyrolized and deposited onto the substrates in open atmosphere. FIG. 5B illustrates the TEM picture of the film, showing nanostructured particulates of LiFePO₄ coated with amorphous carbon. Further the XRD shown in FIG. 5C confirms the Olivine phase of LiFePO₄ in the film. It will be appreciated that the nanostructured Olivine particulates coated with carbon are desired for the cathodic film and thus the principles set forth herein can successfully create the desired cathode directly eliminating intermediate processing steps commonly adopted in industrial practice. Further, the discharge capacity of thus obtained cathodic film is illustrated in FIG. 5D, which further supports the claims of the current teachings.

An exemplary precursor for LiCoO2/C composite cathode comprises water, LiOH, Co-nitrate, and sugar in a pH adjusted solution. Further, additives such as alumina or aluminum phosphate can be added using Al-nitrate and ammonium phosphate in the solution. The sugar content in the solution plays an important role on the stoichiometric balance of the LiCoO2 compound in the film. The resulting molten/semi-molten LiCoO2 particles are deposited as a film 502 onto a current collector 501 such as an aluminum foil as illustrated in FIG. 5A by utilizing a plasma device 201 of FIG. 3B. The solution precursor was successfully pyrolized and deposited onto the substrates in open atmosphere resulting in fine particulates of LiCoO2 coated with carbon. Additional carbon can be added to the film via gaseous precursors 211 as described in the current teachings. In some embodiments, the film can also be obtained following the principles of the current teachings by employing the liquid precursors described herein and the combustion device 251 of FIG. 3C. The choice between plasma or combustion flame depends on the desired density and particulates in the film.

An exemplary precursor for Li(NiCoMn)0.33O2/C composite cathode comprises water, LiOH, Ni-nitrate, Co-nitrate and Mn-nitrate, and sugar in a pH adjusted solution. Further, additives such as alumina or aluminum phosphate can be added using Al-nitrate and ammonium phosphate in the solution. The resulting molten/semi-molten Li(NiCoMn)0.33O2 particles are deposited as a film 502 onto a current collector 501 such as an aluminum foil as illustrated in FIG. 5A by utilizing a plasma device 201 of FIG. 3B. The solution precursor was successfully pyrolized and deposited onto the substrates in open atmosphere resulting in nanostructure lamellar particulates of Li(NiCoMn)0.33O2 coated with carbon. Additional carbon can be added to the film via gaseous precursors 211 as described in the current teachings. In some embodiments, the film can also be obtained following the principles of the current teachings by employing the liquid precursors described herein and the combustion device 251 of FIG. 3C. Further, alternative layer of Ni rich and Ni deficient layers can be achieved by varying the solution precursor's chemistry for enhanced electrode performance.

An exemplary and non-limiting variation to directly fabricate the cathodic film according to the principles of the current teachings, starts with the deposition of a metallic cobalt film employing a plasma device 201 of FIG. 3B and solid powder precursor of cobalt followed by the spraying of LiOH liquid precursor directly onto the film and simultaneous in situ heat treatment. A LiCoO2 502″ cathodic film develops directly on the current collector 501 following these teachings. The charge/discharge behavior of thus obtained cathodic film is illustrated in FIG. 5E demonstrating the functionality of such a film in a Li-ion half cell battery operation. Further, the variation described herein can be adopted for other cathodic films such as LiMn₂O₃ 502′″ illustrated in FIG. 5A.

Exemplary cathodic films described herein are for illustration purposes only and were obtained according to the principles of the current teachings, and they do not intend to limit the full scope of the possible material systems that can be synthesized following the principles of the present disclosure.

### Innovative Anode Manufacturing:

Various material chemistries such as graphite, carbon-silicon, Li₄Ti₅O₁₂, CO₃O₄, and Mn₃O₄ are being explored for the anode, although graphite is most widely used in the industry today. Many current battery manufacturing techniques employ the use of a polymer binder to develop the anodic film of various powder materials. As is for reference, thermal spray technique has also been employed to deposit films of various oxides employing pre-synthesized powders.

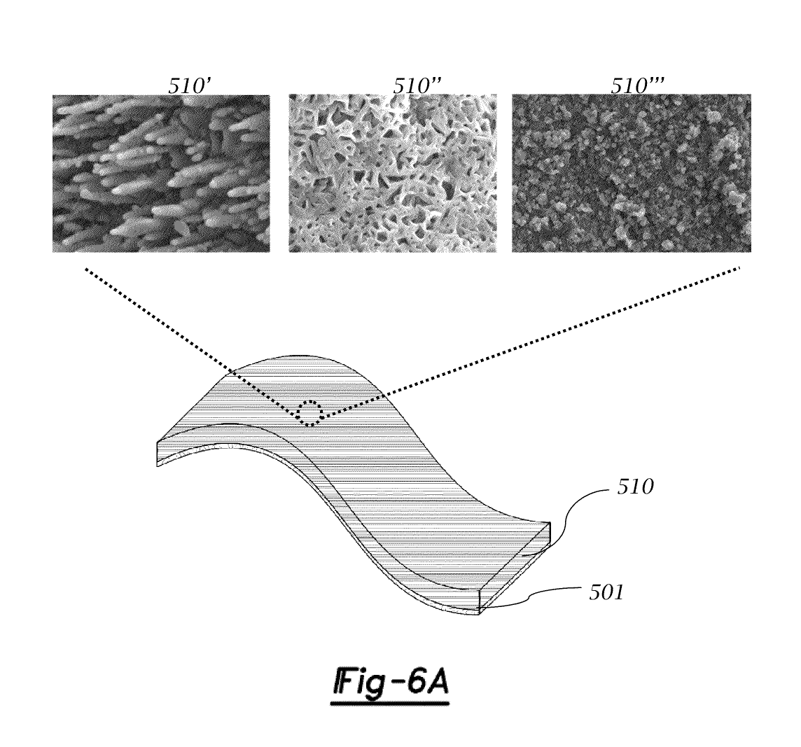

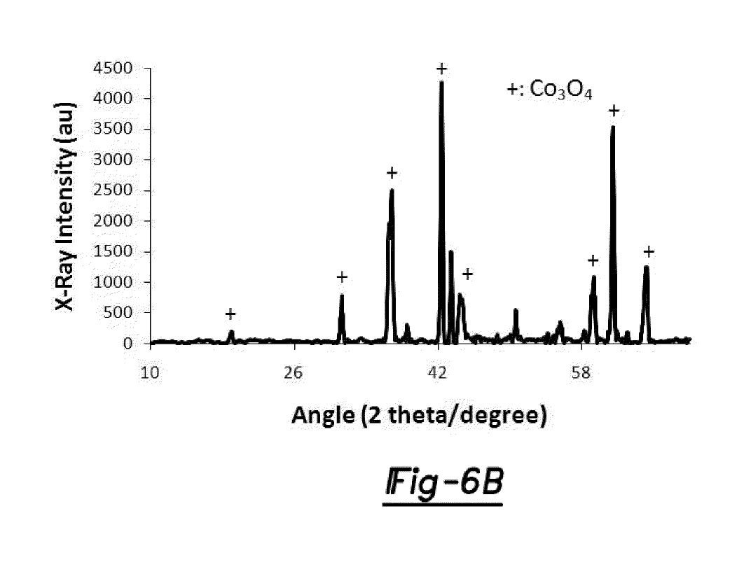

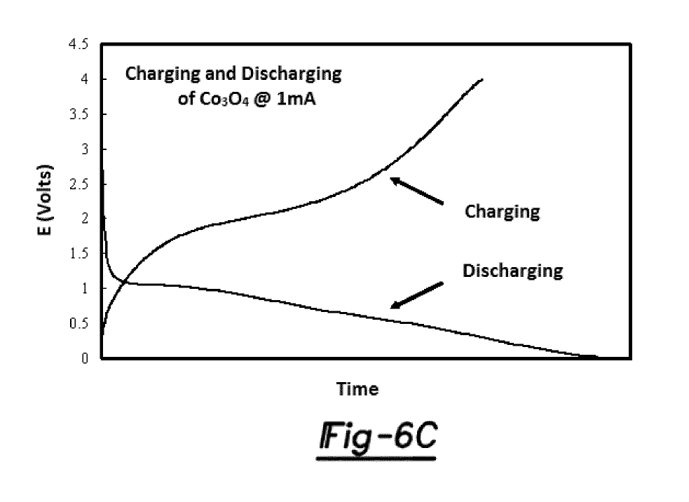

Referring to FIG. 6A, anodic films 510 of various materials can also be directly fabricated on the current collector 501 from solid or solution or gaseous precursors or a combination thereof accompanied by in situ heat treatment according to the principles set forth herein. An exemplary precursor for Co3O4/C composite anode comprises water, Co-nitrate, and sugar in a pH adjusted solution. The solution can be atomized to a plasma or combustion flame to pyrolyze the droplet into Co3O4 particles that can be consolidated into an anodic film on the current collector. Further in situ heat treatment can be applied to modify the phase, chemistry and morphology of the film.

An exemplary and non-limiting variation of the current teachings to directly fabricate the anodic film starts with the deposition of a metallic cobalt film employing a plasma device 201 of FIG. 3B and solid powder precursor of cobalt followed by simultaneous in situ heat treatment in the presence of oxygen. A Co3O4 510″ anodic film was directly obtained on the current collector 501 following these teachings as illustrated in FIG. 6A. The XRD pattern illustrated in FIG. 6B confirms the desired phase of the film. Further, the charge/discharge behavior of thus obtained anodic film is illustrated in FIG. 6C demonstrating the functionality of such a film in a Li-ion half cell battery operation. Further, the principles described herein can be adopted for other anodic films based on many transition metals such as Mn and Ti.

The benefits of thermal spray process include large throughputs and porous coatings, which provide large surface area for faster reaction/oxidation kinetics in the next step, i.e., in situ oxidation/lithiation process. Further, the transition metals, such as Co and Mn sheet metals are expensive compared to their powders (powders are often the end product of their extraction processes, e.g. electrowinning of Mn) and plasma deposition uses the powder precursor. Accordingly, the reaction kinetics in the plasma sprayed porous coatings is much faster than in the case of bulk sheet metal. Often oxide scales developed on the bulk metal flake off due to the strain associated with volume change while the plasma sprayed porous coating can accommodate the strain and stay adherent to the substrate. Thus, nanostructured films with superior charge/discharge cyclability and specific capacity can be manufactured cost effectively. Additionally, the absence of polymers or binders can make these electrodes suitable for high temperature battery applications.

Over the years, Si nanowires and nanoparticles were shown to exhibit very high specific capacity for anodes. A serious limitation of these materials is that the nanostructures degrade during electrode cycling (due to repetitive Li ion insertion and extraction), leading to drastic drop in capacity and hence device degradation. To overcome such material degradation, carbon coating has been utilized on the Si nanoparticles. The carbon coating has been shown to protect the surface and retain the nanostructure intact during the electrode cycling tests. The silicon nanostructures are typically achieved by low volume processes such as CVD.

However, the ability to deposit silicon coating by direct current plasma apparatus 201 on a current collector 501 and subsequent in situ treatment using laser source 208 to make nanostructured surfaces 510′ permits large area anodes to be produced in a simple and cost effective manner. In some embodiments of these current teachings one can use the plasma apparatus 201 to deposit silicon coatings and a catalyst layer to achieve nanostructured surfaces by subsequent in situ treatment.

In some embodiments of these teachings, a gaseous precursor containing silicon can be used in the plasma device to deposit nanoparticles onto current collector 501 to manufacture silicon nanoparticulate based anodes 510′″. Further, these silicon nanoparticulates can be coated with carbon using appropriate gaseous precursors simultaneously, such as acetylene. Additionally, carbon coated silicon nanoparticulates can be deposited on the nanostructured silicon or metallic surfaces (obtained by in situ laser treatment) described herein to create hierarchical anode structures. Alternatively, one can deposit such carbon coated silicon nanoparticles on porous electrodeposited copper to form the anode.

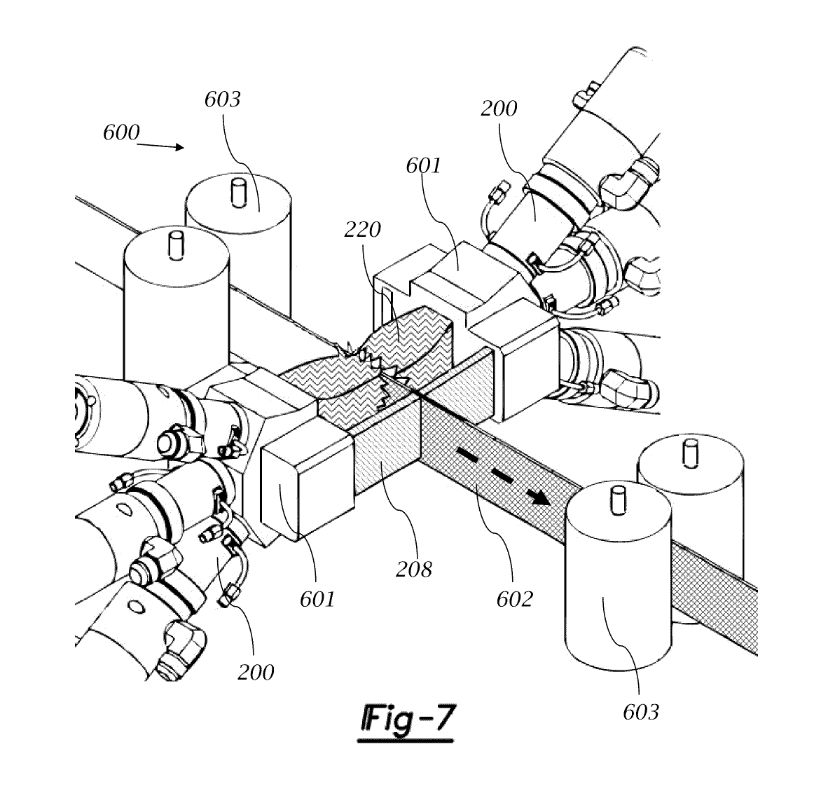

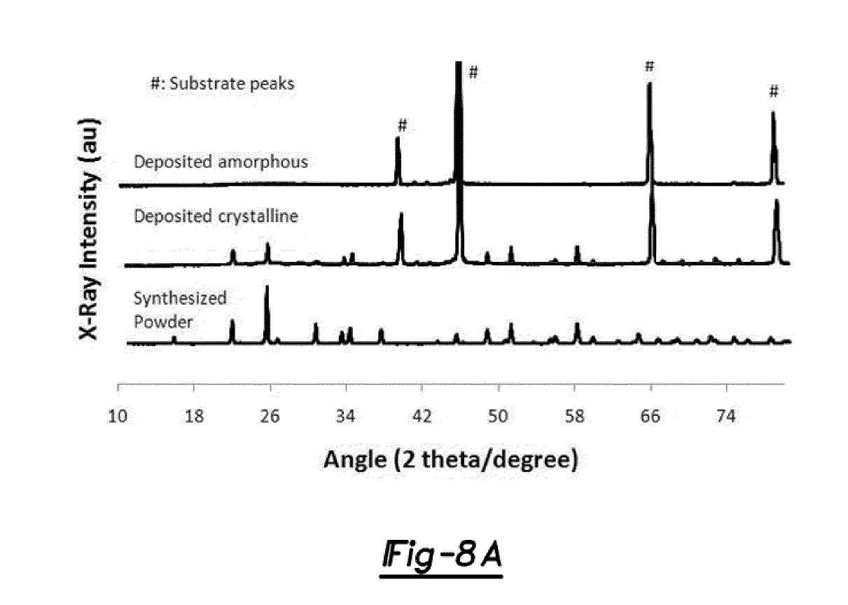

In some embodiments of the current disclosure, multiple spray devices can be assembled to deposit the electrode materials on both sides of the current collector according to the principles of the current teachings in a roll to roll manufacturing configuration 600 as illustrated in FIG. 7. In this embodiment, the spray devices contribute the synthesized materials into a common nozzle 601. Further, the rolls 603 can compress the films after in situ treatment to control the porosity structure of the electrode material. Such embodiment can be adopted for both cathode and anode leading to an industrial battery assembly process, where the separator and electrolyte layers are incorporated forming the entire cell.

### Innovative Electrolyte Manufacturing:

Solid electrolytes are well suited for battery operation at elevated temperatures. Further they provide a safer operating environment. Most of the solid electrolytes are synthesized through solid state or sol-gel methods and the glassy phase is achieved through rapid quenching from the high temperature annealed state.

According to the principles of direct synthesis from precursor solutions set forth herein, appropriate liquid precursors are introduced into plasma device 201 of FIG. 3B to directly synthesize the solid state electrolyte on the electrodes with desired material chemistry, phase and morphology. This capability facilitates the fabrication of monolithic layers wherein the active electrode and solid electrolyte can both be deposited using the plasma spray device sequentially, thus reducing process steps and cost of manufacturing battery cells.

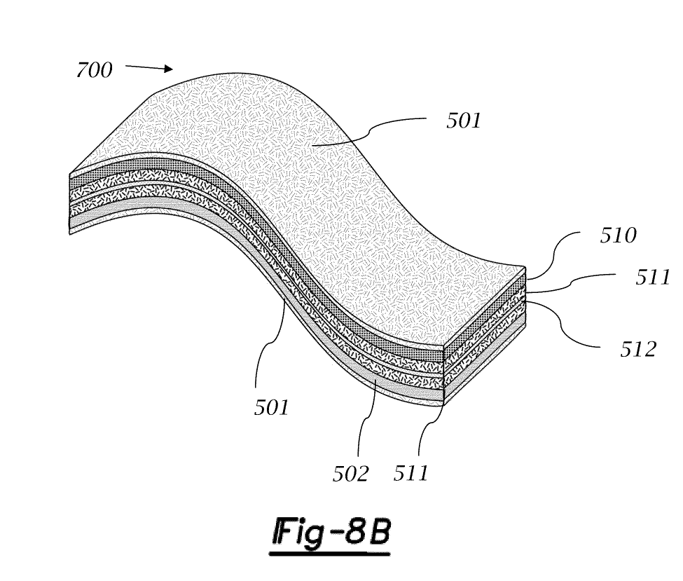

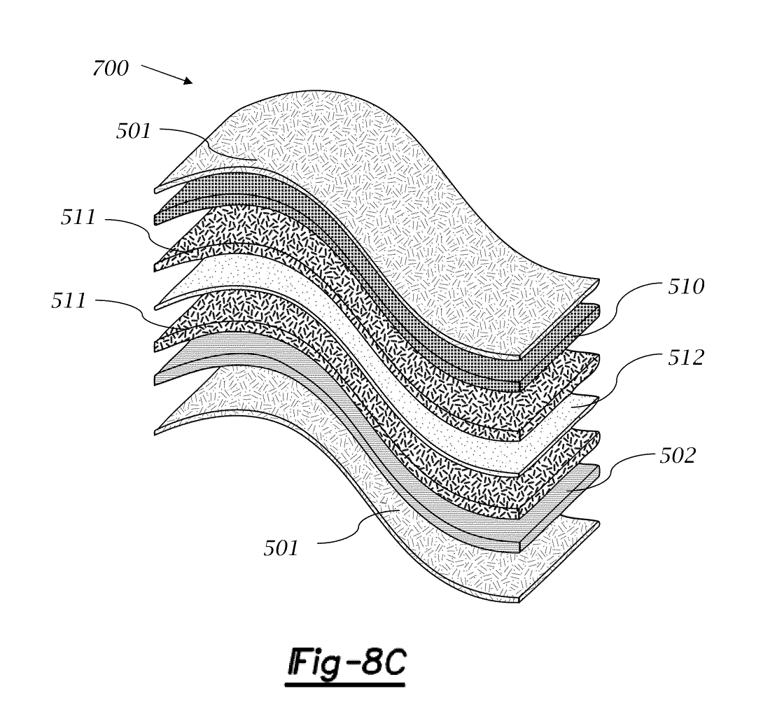

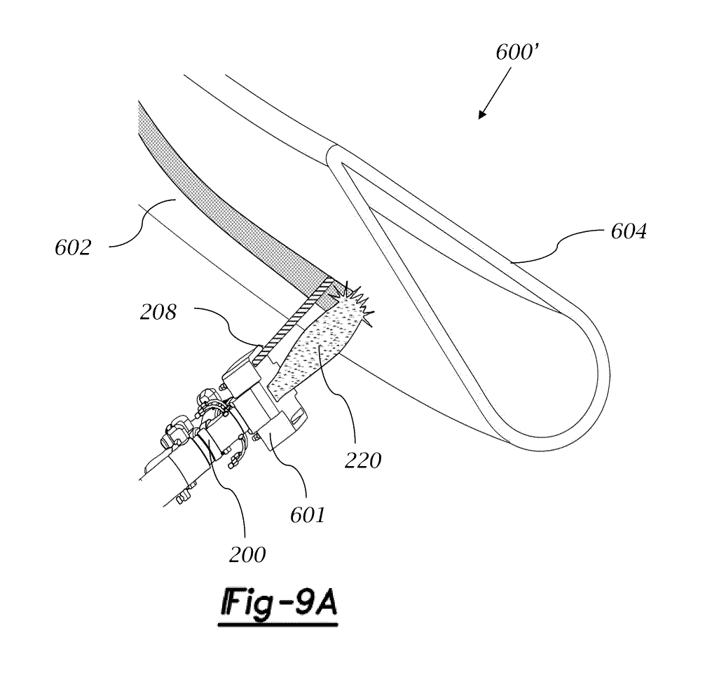

To this end, an exemplary solid electrolyte based on Li₁₊ₓAlₓTi₂₋ₓ(PO₄)₃ [LATP] (x: 0.2-0.5) using liquid precursors was directly synthesized according to the principles of the current teachings. The exemplary solution precursor is comprised of LiOH, Al-nitate, Ti-isopropoxide and ammonium phosphate. The X-ray diffraction patterns of deposited LATP film described here is shown in FIG. 8A, illustrating the possibility of achieving both amorphous as well as crystalline form of the solid electrolyte. The in situ heat treatment can effectively control the phase of the film. Exploiting the flexibility of composition variation possible in the synthesis scheme set forth here, the electrolyte composition can be varied in a wide range favoring good ionic conductivity. In a similar fashion, Li₁₊ₓAlₓGe₂₋ₓ(PO₄)₃ [LAGP] based solid electrolytes can also be synthesized using spray synthesis principles established here by replacing Ti-isopropoxide with Ge-isopropoxide in the solution.

### Innovative Separator Manufacturing:

A separator which possesses high surface area, porosity and good mechanical strength is desirable for best performance. Adopting the principles of current teachings, spray deposition device can be utilized to deposit the separator directly on the electrode or the solid electrolyte. Following this approach, PVDF dissolved in various solvents have been successfully deposited in thin film form. The solvents include n-methylpyrrolidinone (NMP), acetone, methanol etc. Since spray method inherently results in porous and continuous film structures, spray fabricated membranes can be well suited for battery assembly. Further, reinforcements such as fibers or nanotubes can be incorporated into the solution to fabricate separator layers for enhanced mechanical strength.

### Innovative Lithium Ion Battery Manufacturing:

According to the teachings set forth in this disclosure, the direct fabrication of cathodes, anodes, solid electrolytes and separators sequentially, offers unique advantages to build monolithic batteries uncommon to conventional battery industry. Referring to FIGS. 8B and 8C, in some exemplary embodiments, 700, the entire battery cell comprising current collector 501, cathode 502, electrolyte 511, an optional separator 512, anode 510 and the second current collector 501 can be sequentially built into a monolithic structure. The current collectors can be built using solid precursor powders of conductive metals such as Al, Cu, or stainless steel by the plasma spray device. This ability provides tremendous geometric and functional capability to the manufacturing technique demonstrated here.

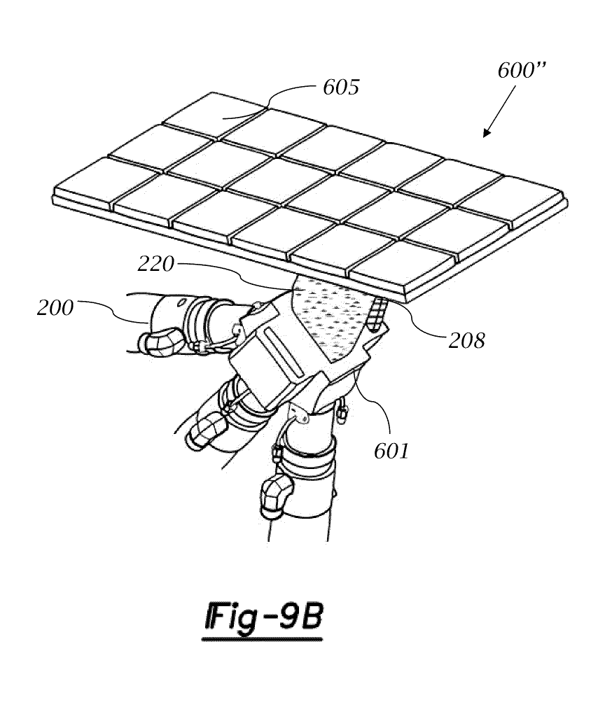

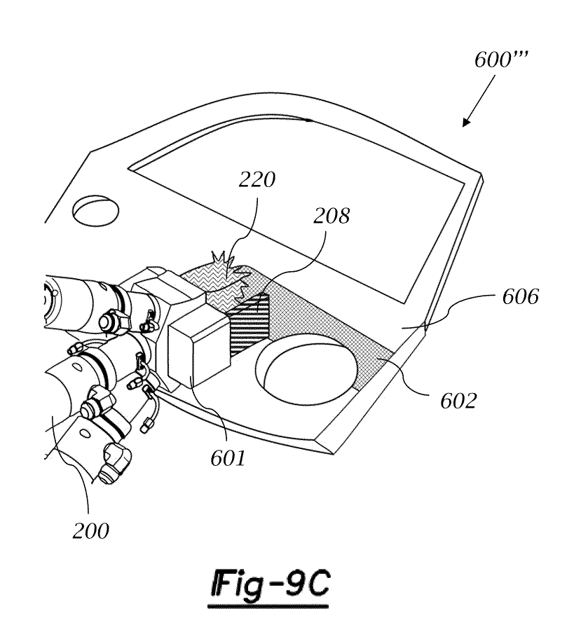

Referring to FIG. 9A, complex battery cell 602 can be built onto the wings or frame of an airplane conforming to the contour of the structure by spray device 200, according to the principles of the current teachings. Such battery cells can save space and provide enormous storage capabilities to aerospace systems. Storage systems of this nature can provide power for an entire drone system without significant alteration to the geometry and space.

Moreover, in some embodiment of the current teachings as shown in FIG. 9B, a monolithic battery can be built below a solar cell to provide local storage capability. Such capability can eliminate the need for a central storage unit. Further, the thermal management of such batteries can easily be done due to the open architecture of the battery.

In some embodiments, as shown in FIG. 9C, the monolithic battery according to the current teachings can be built onto the automotive body structure. Current electric vehicles are designed around the available shape of the battery pack. With the geometric freedom possible as described here, automotive structures can be designed according to functional and styling needs and the battery can be fabricated to be accommodated in the available space.

Exemplary configurations described herein are for illustration purposes only and they do not intend to limit the full scope of the possible configurations and combinations that can be achieved following the principles of the present disclosure. The principles of current teachings can be applied for individual components such as the electrodes or electrolytes or the separator or any combination thereof.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of fabricating a battery member from a precursor, said method comprising:
providing a precursor having at least one component dissolved in said precursor; and
thermal spray depositing said precursor on a substrate to form a coating layer such that said at least one component is synthesized within said thermal spray prior to being deposited on said substrate.

2. The method according to claim 1 wherein said providing a precursor having at least one component dissolved in said precursor comprises providing a precursor having at least one component chemically dissolved in said precursor solution.

3. The method according to claim 1, further comprising:
heat treating said coating layer to achieve a predetermined chemistry, phase, or morphology.

4. The method according to claim 3 wherein said heat treating said coating layer comprises heat treating said coating using a laser source.

5. The method according to claim 3 wherein said heat treating said coating layer comprises heat treating said coating using a plasma source.

6. The method according to claim 3 wherein said heat treating said coating layer comprises heat treating said coating using a combustion flame.

7. The method according to claim 3 wherein said heat treating said coating layer comprises heat treating said coating using a furnace.

8. The method according to claim 3 wherein said heat treating said coating layer comprises heat treating said coating using induction heating.

9. The method according to claim 1 wherein said heat treating is at least partially completed prior to deposition of a subsequent coating layer.

10. The method according to claim 1 wherein said providing a precursor having at least one compound dissolved in said precursor comprises providing a liquid precursor.

11. The method according to claim 1 wherein said providing a precursor having at least one compound dissolved in said precursor comprises providing a gaseous precursor.

12. The method according to claim 1 wherein said precursor comprises water, Iron Oxalate, LiOH, Ammonium Phosphate, and sugar in a pH adjusted solution.

13. The method according to claim 1 wherein said precursor comprises water, LiOH, Co-nitrate, and sugar in a pH adjusted solution.

14. The method according to claim 1 wherein said precursor comprises water, LiOH, LiOH, Ni-nitrate, Co-nitrate, Mn-nitrate, and sugar in a pH adjusted solution.

15. The method according to claim 1 wherein said precursor comprises water LiOh, Al-nitate, Ti-isopropoxide and ammonium phosphate in a pH adjusted solution.

16. The method according to claim 1 wherein said precursor comprises water LiOH, Al-nitate, Ge-Isopropoxide and ammonium phosphate in a pH adjusted solution.

17. The method according to claim 1 wherein said thermal spray comprises a plasma source.

18. The method according to claim 1 wherein said thermal spray comprises a combustion source.

19. The method according to claim 1 wherein said thermal spray comprises a preheated gaseous source.

20. The method according to claim 1, further comprising:
adding one of an acid or base to said precursor to achieve a predetermined pH level.

21. The method according to claim 1, wherein said precursor is entirely a solution comprising an elemental source for a desired cathodic compound and a carbon source.

22. The method according to claim 1, wherein said precursor is entirely a solution comprising an elemental source for a desired anodic compound and a carbon source.

23. The method according to claim 1, wherein said precursor is entirely a solution comprising an elemental source for a desired electrolyte compound.

24. The method according to claim 1, wherein said precursor is entirely a solution comprising an elemental source for a desired separator compound.

25. The method according to claim 1, wherein said precursor is a slurry comprising suspended particles for a desired cathodic compound and a solution.

26. The method according to claim 1, wherein said precursor is a slurry comprising suspended particles for a desired anodic compound and a solution.

27. The method according to claim 1, wherein said precursor is a slurry comprising suspended particles for a desired electrolyte compound and a solution.

28. The method according to claim 1, wherein said precursor is a slurry comprising suspended particles for a desired separator compound and a solution.
